(19) United States
(12) Patent Application Publication
(10) Pub. No.: US 2001/0040551 A1
(43) Pub. Date: Nov. 15, 2001

(54) HAND-HELD REMOTE COMPUTER INPUT PERIPHERAL WITH TOUCH PAD USED FOR CURSOR CONTROL AND TEXT ENTRY ON A SEPARATE DISPLAY

(75) Inventors: WILLIAM ALLEN YATES, CAMARILLO, TX (US); MICHAEL R. SMITHER, CASTAIC, CA (US); JACK A. SEGAL, OXNARD, CA (US); STEVEN B. BRANTON, VENTURA, CA (US); JAMES D. TICKLE, THOUSAND OAKS, CA (US); JOHN K. MARTINELLI, CAMARILLO, CA (US)

Correspondence Address: PAUL M SCHWARTZ, BROOKS & KUSHMAN P C, 1000 TOWN CENTER TWENTY SECOND FLOOR, SOUTHFIELD, MI, 48075

(73) Assignee: Interlink Electronics, Inc., Camarillo (CA)

(21) Appl. No.: 09/363,177

(22) Filed: Jul. 29, 1999

(51) Int. Cl. G09G 5/00

(52) U.S. Cl. 345/156; 345/173

(57) ABSTRACT

A hand-held remote computer input peripheral for communicating with a host computer having a display screen. An operator holds the input peripheral in space with a first hand. The input peripheral includes activation mode buttons each corresponding to a respective activation mode of the touch pad for controlling the display screen. The activation modes include a text entry mode for entering text on the display screen and a cursor control mode for controlling a cursor on the display screen. The input peripheral further includes a touch pad. The operator manipulates the touch pad using a second hand while holding the input peripheral with the first hand to perform functions associated with the activation modes for controlling the display screen. The text entry mode includes an annotation mode for enabling the operator to draw on to the display screen and a type mode for enabling the operator to print text on to the display screen. The operator draws on to the display screen in the annotation mode by moving a finger of the second hand across the touch pad. The operator prints text on to the display screen in the type mode by moving a finger of the second hand across the touch pad to handwrite the text and conversion software converts the handwritten text to printed text. The operator prints text on to the display screen in the type mode by moving a finger of the second hand across the touch pad to select letters of an on-screen keyboard displayed on the display screen.

### TECHNICAL FIELD

The present invention relates to remote computer input peripherals and, more particularly, to a remote computer input peripheral used to control presentation projectors, electronic meeting hardware and software, personal computer (PC) based video and teleconferencing, enhanced television (TV), and Internet based communications.

### BACKGROUND ART

The proliferation of computer driven systems and appliances into arenas that were traditionally non-computer related has rendered conventional user input devices inadequate, and sometimes obsolete. Considerable resources are being spent to create new user-interface paradigms using pen and voice and on-screen remote control displays.

An electronic meeting environment typically includes a PC and a number of communications appliances. The communications appliances include white boards, presentation projectors, and video and teleconferencing systems. People use the communications peripherals for white board applications involving interactive presentations and meetings, and collaborative data sharing sessions.

An electronic meeting environment does not need to be a single room nor limited to business purposes. Rather, an electronic meeting room can be a virtual room where one or more persons in different physical locations are connected together via the Internet or some other communications network for personal or business communications.

A user interface controls remote location meetings and conferences where computerized data and document sharing takes place through a teleconferencing or a video conferencing medium. Currently, the user interface for the above applications involves employing multiple devices such as a projector remote control, a microphone, a mouse, a wireless keyboard, a digitizer pad, and a phone. A problem with employing multiple devices for the user interface is that users must manipulate many devices making the user interface less friendly.

Pad-entry paradigms employing touch pads and digitizer pads or tablets have been developed which incorporate the features of some of the multiple devices. It is desirable that one hand holds the touch pad in space while the other hand manipulates the touch pad with either a finger(s) or a stylus for performing mouse functions and entering text (printed or written) on an on-screen display. A problem with prior art pad-entry paradigms is that the hand manipulating the pad needs to be constantly lifted from the pad surface to perform clicks or other entry functions (usually the activation of hard or soft keys). This interruption of mousing or graphic capturing tasks causes inconvenience and renders the device less friendly and usable. Further, prior art pad-entry paradigms have not been designed as one unit encompassing mouse and printed and written text entry on-screen display functions.

Other pad-entry paradigms require the pad to be set down, thereby freeing up the holding hand to perform other functions. Some current paradigms use expensive pad technology solutions to facilitate usage such as a specialized stylus or pen that requires either activation of buttons on the pen or pressing the stylus tip against the pad. Other paradigms require a pad designed to sense proximity of a special stylus to accomplish certain functions. These prior art paradigms require specialized technologies that are expensive and less practical to do in a portable, wireless device.

Further, the rapidly emerging phenomena known as enhanced TV demands the development of a new type of remote control solution. Traditional home entertainment systems are already difficult to control, often requiring the use of multiple button burdened remote controls. The emergence of TV based interactivity and its requirement for users to frequently control and communicate with their systems in new, non-traditional ways further burdens already crowded and complicated remote controls. For enhanced TV to succeed with mass adoption, the trend towards increasing control complexity must be addressed.

Enhanced TV and related applications require the extensive use of graphic user interfaces (GUI) and on-screen displays/menus. The four arrow buttons on traditional family room remote controls produce squarish, one box at a time control that is too cumbersome to navigate sophisticated on-screen displays.

Internet surfing within, or outside of, an enhanced TV setting requires fluid cursor control, click, and select capabilities. Intuitive point and click capabilities are alien to typical entertainment remote controls. Text and numerical entry is a necessity for Internet surfing, home shopping, and email communications. Currently, keyboards are used for text and numerical entry, but are too large and unattractive to be stationed on a person's coffee table.

In an enhanced TV setting, handwriting, signing, and drawing are the two way messaging options of choice when a personal touch is desired, where non-computer users communicate, or when securing on-line purchases. However, a typical corded digitizer tablet is an inconvenient, expensive, and unattractive peripheral in a family room environment.

### SUMMARY OF THE INVENTION

Accordingly, it is an object of the present invention to provide a remote computer input peripheral that combines several input requirements, currently managed via multiple devices, into one intuitive hand-held input device.

It is another object of the present invention to provide a hand-held remote computer input peripheral having a touch pad that enables the harmonious working of one hand holding the peripheral with the other hand manipulating the touch pad.

It is a further object of the present invention to provide a remote hand-held touch pad sensor peripheral held by one hand while being addressed by the other hand either with a finger(s) or stylus in which the fingers and/or thumb of the holding hand activate input buttons on the peripheral simultaneously, or in conjunction with, input activities of the touch pad addressing hand.

It is still another object of the present invention to provide a remote hand-held touch pad sensor peripheral that acts as a pen, a mouse, and a keyboard for Internet conferencing, meeting, and presentations.

It is still a further object of the present invention to provide a remote hand-held touch pad sensor peripheral that has write entry, print entry, and cursor control activation modes.

It is still yet another object of the present invention to provide a remote hand-held touch pad sensor peripheral that interprets gestures on the touch pad as commands for Internet and enhanced TV services.

It is still yet a further object of the present invention to provide a remote hand-held touch pad sensor peripheral that maps its touch pad area to various display based control panels and menus on a TV for an operator to remain focused on the TV while manipulating the touch pad.

Yet, it is still another object of the present invention to provide a remote hand-held touch pad sensor peripheral that transmits voice as well as data for Internet based telephony and audible commands in an enhanced TV service environment.

In carrying out the above objects and other objects, the present invention provides a hand-held remote computer input peripheral for communicating with a host computer having a display screen. The input peripheral includes a housing having a top surface, first and second opposed side surfaces, and a rear surface. An operator holds the housing in space by gripping the first side surface with a first hand. A plurality of activation mode buttons are positioned in the top surface of the housing. Each of the activation mode buttons correspond to a respective activation mode of the touch pad for controlling the display screen. The activation modes of the touch pad include a text entry mode for entering text on the display screen and a cursor control mode for controlling a cursor on the display screen. The operator switches between activation modes by pressing the activation mode buttons with the second hand. A touch pad is positioned in the top surface of the housing. The operator manipulates the touch pad using a second hand while holding the housing with the first hand to perform functions associated with the activation modes for controlling the display screen.

The advantages of the present invention are numerous. The present invention allows the harmonious working of both hands of the operator, i.e., one hand holding the peripheral and manipulating buttons on the peripheral while the other hand manipulates the touch pad of the peripheral. The present invention combines drawing, keyboard, and mouse functions in one remote hand-held unit.

These and other features, aspects, and embodiments of the present invention will become better understood with regard to the following description, appended claims, and accompanying drawings.

### BRIEF DESCRIPTION OF THE DRAWING

FIG. 1 is a perspective view of a remote computer input peripheral in accordance with a preferred embodiment of the present invention;

FIG. 2 is a top plan view of the input peripheral shown in FIG. 1;

FIG. 3 is a rear plan view of the input peripheral shown in FIG. 1;

FIG. 4 is a side plan view of the input peripheral shown in FIG. 1;

FIGS. 5-10 are detailed drawings of the activation mode buttons of the input peripheral shown in FIG. 1;

FIGS. 11-15 are detailed drawings of the user-definable function keys of the input peripheral shown in FIG. 1;

FIG. 16 is a side click button of the input peripheral shown in FIG. 1;

FIG. 17 is a forward click button of the input peripheral shown in FIG. 1;

FIG. 18 is a perspective view of a remote computer input peripheral in accordance with a second embodiment of the present invention;

FIG. 19 is a perspective view of a remote computer input peripheral in accordance with a third embodiment of the present invention;

FIG. 20 illustrates a box displayed in the on-screen display of the computer or television when the input peripheral is in the annotation mode;

FIG. 21 illustrates a drawing written in the box displayed on the on-screen display of the computer or enhanced TV when the operator manipulates the touch pad;

FIG. 22 illustrates a new box displayed in the on-screen display of the computer or enhanced TV when the operator reaches the end of the first box;

FIG. 23 illustrates movement of the box displayed on the on-screen display of the computer or enhanced TV;

FIG. 24 illustrates enlargement of the box displayed in FIG. 20;

FIG. 25 illustrates an email message handwritten in the on-screen display of the computer or enhanced TV;

FIG. 26 illustrates a main menu displayed in the on-screen display of the computer or enhanced TV;

FIG. 27 illustrates a TV program guide displayed in the on-screen display of the computer or enhanced TV;

FIG. 28 illustrates an email directory displayed in the on-screen display of the computer or enhanced TV;

FIG. 29 illustrates a telephone directory displayed in the on-screen display of the computer or enhanced TV; and

FIG. 30 illustrates an on-screen numerical keyboard 180 displayed on the enhanced TV.

### BEST MODES FOR CARRYING OUT THE INVENTION

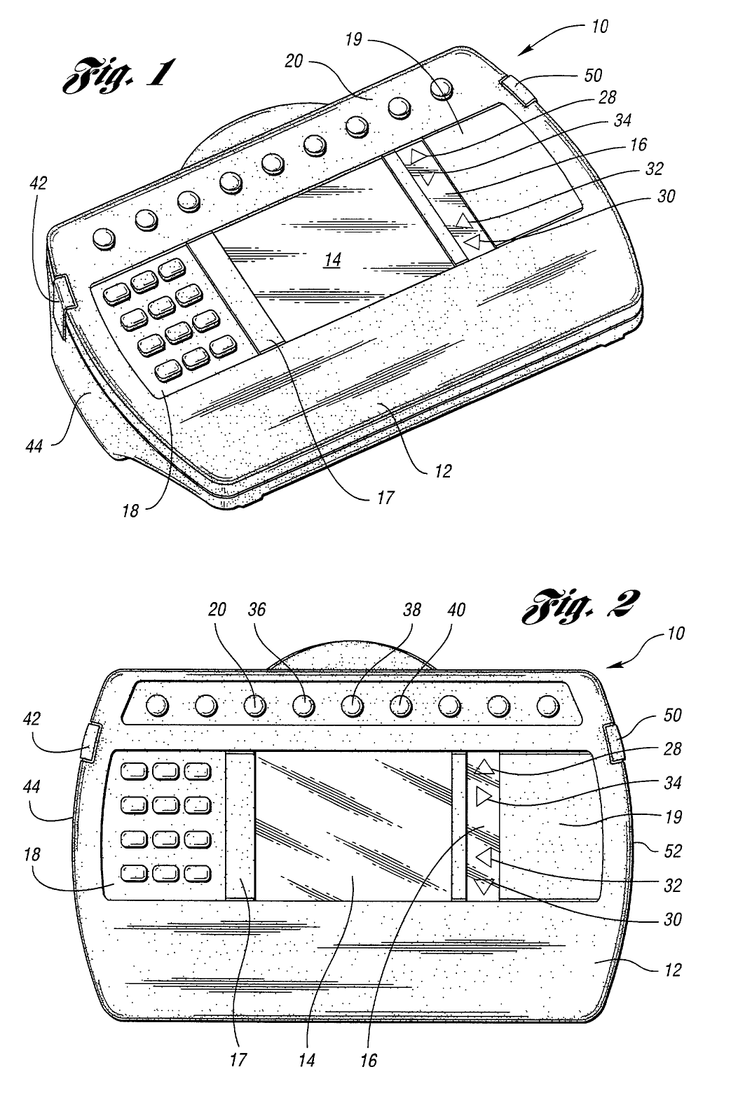

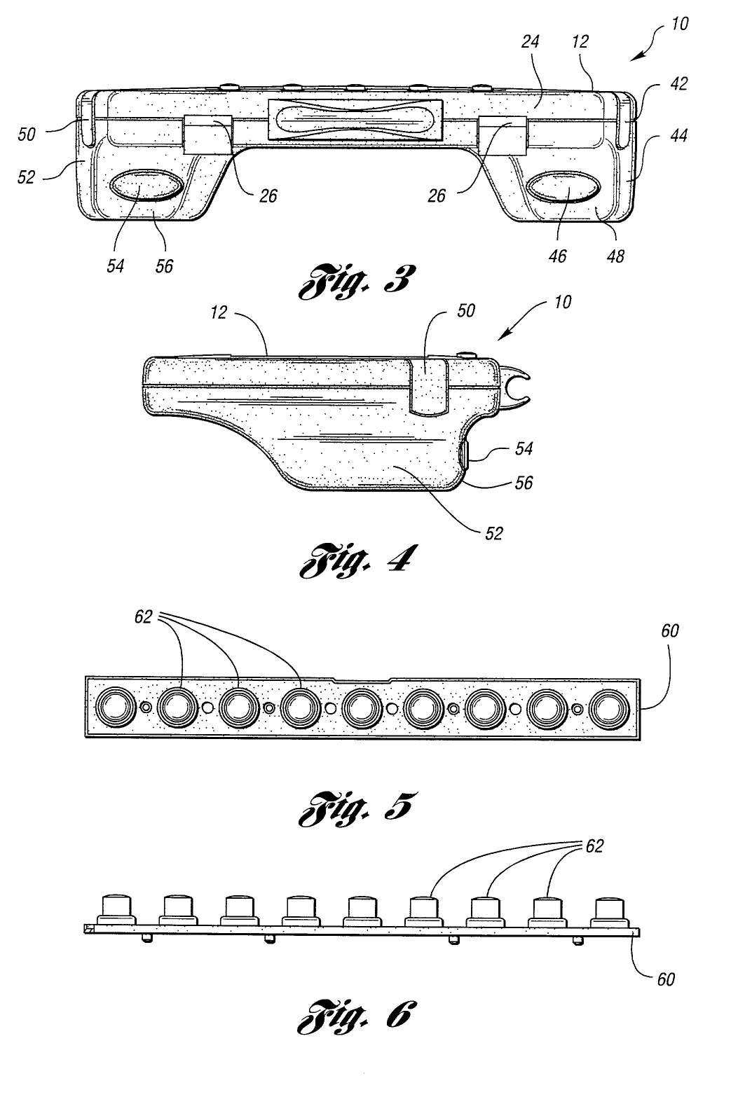

Referring now to FIGS. 1-4, a remote computer input peripheral 10 in accordance with a preferred embodiment of the present invention is shown. Input peripheral 10 includes a top surface 12 having a touch pad 14, a pan and scroll bar region 16, a set of user-definable or preset function keys 18, and a row of activation mode buttons 20. Touch pad 14 provides information indicative of the position of an operator's finger or stylus touching the touch pad to a computer, or an enhanced television (TV) via a set top box, (not shown) through a communications link located on a rear surface 24 of input peripheral 10. In this description, computer and enhanced TV are meant to be synonymous. The communications link communicates with the computer using a hard wire connection (not shown), optically with a pair of light emitting devices (LEDs) 26, or by radio frequency communications. The computer processes the information from touch pad 14 to control an on-screen display. The on-screen display of the computer may include a graphical user interface, a cursor, and other objects. An operator selects commands or manipulate objects in the on-screen display of the computer by using input peripheral 10.

Touch pad 14 reports the entry of pressure, relative motion, relative position, absolute position, absolute motion, tap, double-tap, and tap-and-drag inputs on the touch pad to the computer. Pan and scroll bar region 16 allows the operator to use four scrolling functions (up, down, left, and right) by pressing on four separate areas of the region which are marked by respective arrows 28, 30, 32, and 34. User-definable or preset function keys 18 invoke commands assigned to the keys in software.

Activation mode buttons 20 switch the operation of touch pad 14 (through computer host software) between different modes. Preferably, touch pad 14 has at least three modes of operation: annotation, typing, and pointing. The annotate mode allows the operator to annotate, write, and draw using a finger or stylus; the typing mode gives the operator access to a keyboard; and the pointing (navigate) mode provides mouse capabilities to the operator. Accordingly, activation mode buttons 20 include an annotation (draw/write) mode button 36, a type mode button 38, and an absolute pointing mode button 40. The operator selects the mode of touch pad 14 by selecting one of activation mode buttons 20 and switches between modes by selecting different activation mode buttons.

The annotation mode allows the operator to annotate objects currently being showed on the on-screen display of the computer or enhanced TV. For instance, the operator may annotate projected slides to underscore a message, handwrite notations over documents, or simply draw freehand. In the annotation mode, the operator uses a stylus or finger to write on touch pad 14 to annotate the objects of the on-screen display.

Preferably, input peripheral 10 includes the capability to allow the annotations to be saved with the object that has been annotated. Annotations can either be saved as an OLE object in the annotated document or as an OLE object in an annotation file. Annotations can be made in different colors using “nibs” of different sizes, shapes, and angles. Annotations can be erased using different sized erasers. The current pen color, nib size and shape, and eraser size are stored by the host computer. A pen tool is provided that allows an ink color to be selected from a plate of colors and different nibs and erasers from trays of each.

When touch pad 14 is in the annotation mode the cursor displayed on the on-screen display changes from the standard windows arrow to a precession select cursor or pen. To leave ink, the operator clicks and holds a left side click button 42 located on a left side surface 44 of input peripheral 10 using his left thumb while holding the left side surface of the input peripheral with his left hand. When the operator selects left side click button 42 the cursor changes to a handwriting cursor in the color of the currently selected ink. Moving the cursor around the on-screen display by manipulating touch pad 14 with his right hand leaves ink such that the top of the nib is at the upper left tip of the handwriting cursor.

To erase, the operator clicks and holds a left forward click button 46 located on left rear surface 48 of input peripheral 10 using the forefinger of his left hand. When the operator selects left forward click button 46 the pen changes to an eraser. Moving the eraser around the on-screen display by manipulating touch pad 14 with his right hand erases the annotation such that the area erased is a circle centered on the current position of the eraser. The size of the circle is based on the current eraser size selected.

Referring now to FIGS. 20-25, with continual reference to FIGS. 14, operation of the annotation mode will further be described. After the operator selects the annotation mode by tapping annotation mode button 36, a box 120 appears in on-screen display 122 of the host computer and the cursor changes to pen 124 as shown in FIG. 20. Preferably, box 120 is smaller than on-screen display 122 and is proportional to the size and shape of touch pad 14. Box 120 represents the area in which pen 124 moves when the operator's finger or stylus moves on touch pad 14. The operator moves his finger on touch pad 14 to move pen 124 within box 120. The operator draws an object such as face 126 in on-screen display 122 as shown in FIG. 21 by moving his finger of his right hand on touch pad 14 while holding left side click button 42 with his left hand.

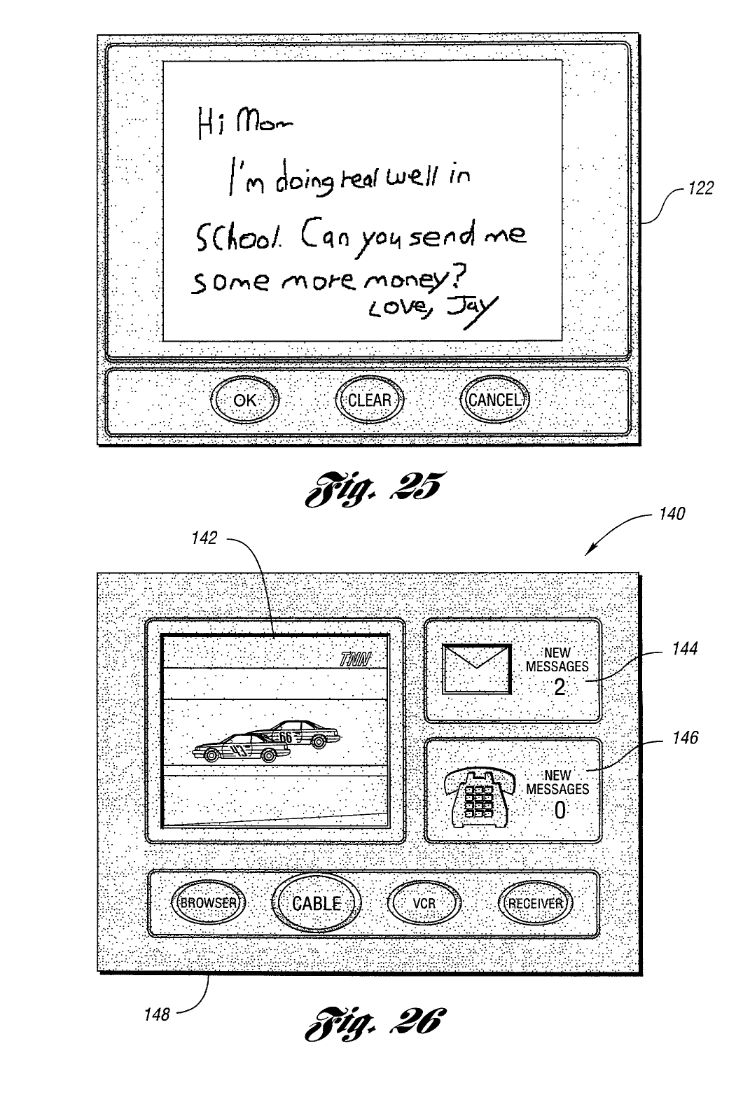

When writing horizontally, for instance, from right to left, the operator will reach the edge of touch pad 14 and the edge of box 120. The operator then clicks left forward click button 46 to jump box 120 to the right as a new box 128 in on-screen display 122 as shown in FIG. 22. This allows the operator to write on the whole on-screen display with semi-automatic box advancement. The operator can also move box 120 around on-screen display 122 as shown in FIG. 23 by holding left forward click button 46 with his left hand while moving his right hand across touch pad 14. The operator can also enlarge (or reduce) the size of box 120 as shown in FIG. 24 by double right clicking and then holding left forward click button 46 with his left hand while moving his right hand across touch pad 14. An arrow 130 appears on a corner of box 120 to indicate enlargement and reduction of the box.

A pen tool control window is used to change nib size, shape, angle, ink color, and eraser size. The pen tool control window is assigned to one of function keys 18. Accordingly, the pen tool control window can be invoked by the hand holding input peripheral 10 while the other hand is manipulating touch pad 14.

When the pen tool control window is displayed in on-screen display 122, the cursor is put in relative mode and is restricted to moving within the pen tool control window. Closing the pen tool control window reverts the cursor to the mode it was in when the pen tool control window was invoked, such as absolute mode. The pen tool control window contains separate controls for changing nib size, shape, angle, ink color, and eraser size.

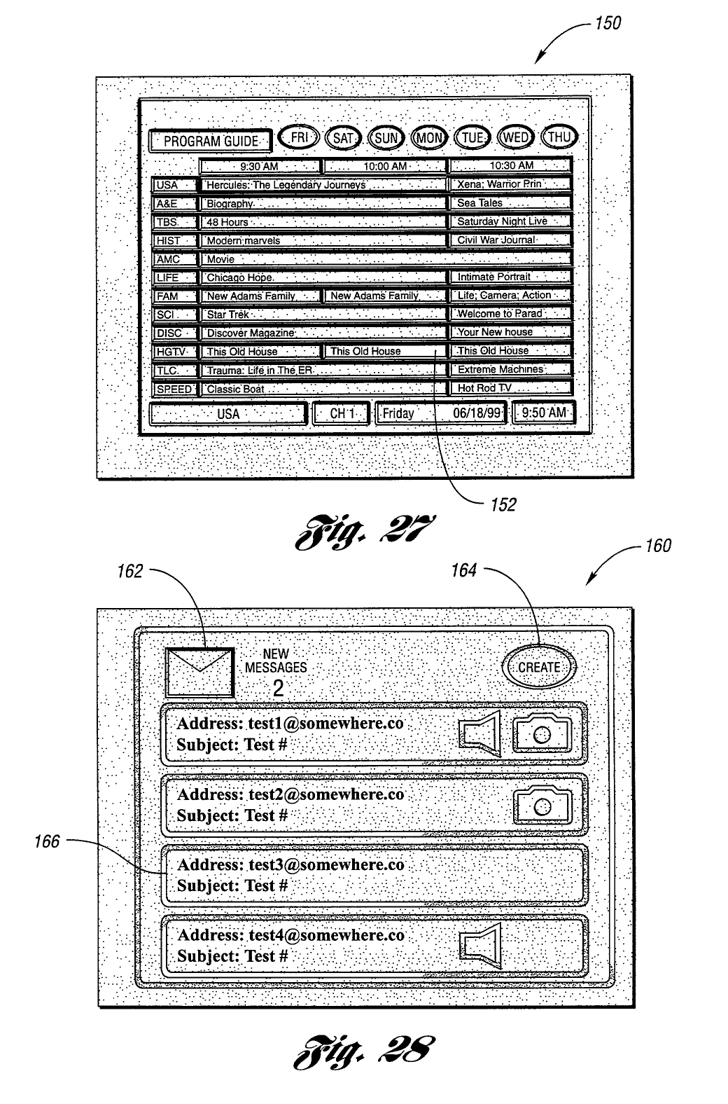

In essence, the annotation mode is the electronic equivalent of allowing the operator to take a marker and write on the glass face of the on-screen display. For instance, the operator may write his signature to electronically sign for purchases made via Internet shopping or simply handwrite a personal email message as shown in FIG. 25.

In the pointing mode, touch pad 14 operates as a typical computer mouse and the operator manipulates the touch pad with his right hand to control a cursor displayed in on-screen display 122. Pointing is a relative task. Touch pad 14 supports a single tap by a finger or stylus as a click of left side click button 42, a double tap as a double click of the left side click button, and a tap and drag as holding the left side click button while the mouse is in motion. Touch pad 14 also works in conjunction with left forward click button 46 to perform mouse clicks. Scrolling functions (up, down, left, and right) are performed by selecting respective arrows 28, 30, 32, and 34 of pan and scroll bar region 16. Pan and scroll bar region 16 is pressure sensitive to allow the operator to control the rate of scrolling as a function of the pressure exerted on the pan and scroll bar region. Input peripheral 10 incorporates one handed point and click utility when cursor control is required in the pointing mode.

The area of touch pad 14 is mapped to various display based control panels and menus displayed in the on-screen display. This allows the operator to manipulate touch pad 14 for precise cursor control to select panels and menus displayed in the on-screen display while remaining visually focused on the on-screen display.

In the typing mode, the operator can input ASCII characters to the host computer by handwriting them on touch pad 14. Input peripheral 10 includes pen to text handwriting recognition software as known in the art to support the typing mode. In operation, the operator handwrites onto touch pad 14 using a finger or stylus with his right hand while holding input peripheral 10 with his left hand. While the operator is writing, the handwriting recognition software converts the handwriting on touch pad 14 to printed text on the on-screen display of the host computer. In addition to allowing an operator to handwrite text, input peripheral 10 works in conjunction with an on-screen keyboard of the host computer to allow the operator to type text for such applications as Internet addresses, messages, and editing of documents.

Referring now to FIGS. 26-30 with continual reference to FIGS. 1-4, the operation of input peripheral 10 in an enhanced TV environment will now be described in further detail. An enhanced TV is a TV configured for cable video programming, Internet browsing, Internet telephony, video cassette recording (VCR), stereo receiver, and the like.

Initially, a main menu 140 is displayed on the enhanced TV. The area touch pad 14 is mapped to the area of main menu 140. Main menu 140 includes a visual screen 142 showing the program on the enhanced TV, an email message panel 144, an Internet telephone message panel 146, and a TV operating mode panel 148. TV operating mode panel 148 includes buttons associated with browser, cable, VCR, and receiver enhanced TV modes of operation. In the browser mode, the enhanced TV functions as an access device for Internet communications and visual screen 142 displays Internet sites. In the cable mode, the enhanced TV receives video signals from a remote source as generally known. In the VCR mode, the enhanced TV shows prerecorded videos. In the receiver mode, the enhanced TV functions as a stereo receiver for receiving audio signals from a remote source.

The operator controls touch pad 14, in the pointing mode, to select an enhanced TV operating mode by using finger motions (gestures) on touch pad 14. These gestures are already known—i.e., do not need—learning because they emulate standard entertainment control icons. For instance, the operator may select cable to be the enhanced TV operating mode by moving his finger to the area of touch pad 14 corresponding to the cable button of TV operating mode control panel 148 as shown in FIG. 26. Main menu 140 then displays the selected cable channel in visual screen 142 of the enhanced TV. The operator may change the channel displayed in visual screen 142 by moving his finger across touch pad 14 when a TV program guide 150 is displayed on the enhanced TV as shown in FIG. 27. For instance, to select “This Old House” on the HGTV channel, the operator moves his finger to the area of touch pad 14 corresponding to rectangle area 152 in TV program guide 150.

In addition to supporting gesture commands by touching touch pad 14, input peripheral 10 includes voice recognition software to support the transmission of voice commands to operate standard system features. For example, instead of moving his finger to the area of touch pad 14 corresponding to the cable button of TV operating mode control panel 148 to select cable, the operator simply says “cable”. Similarly, to select the VCR mode, the operator says “VCR” or “This Old House” to select that program. Input peripheral 10 includes a microphone for receiving audio voice commands and signals and a transmitter for transmitting the audible signals to the enhanced TV.

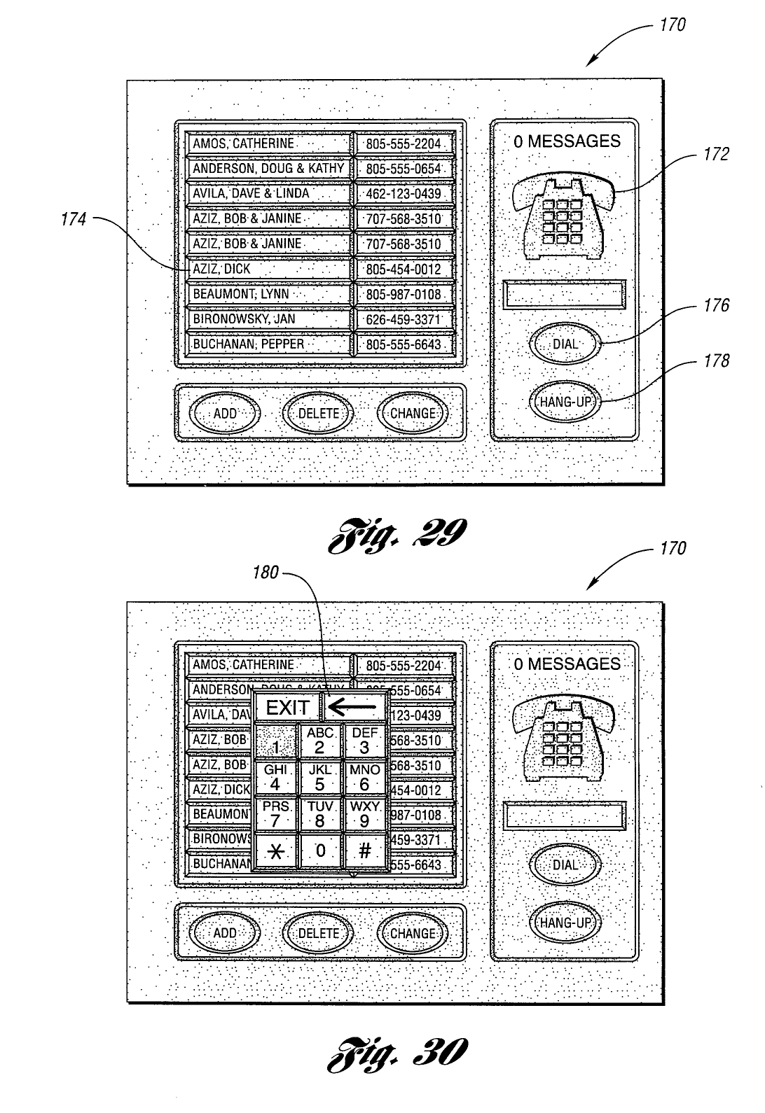

The operator may select email message panel 144 displayed in main menu 140 by moving his finger over touch pad 14 corresponding to the email message panel. In response, an email directory 160 is displayed on the enhanced TV as shown in FIG.28. The operator may open received email messages by moving his finger over touch pad 14 corresponding to the messages, for example, new message area envelope 162. The operator may create an email message by selecting create area 164 of email directory 160. The operator then selects the annotation or text entry mode to write or print a message. The operator may also attach a voice snippet to the email message. The operator then selects an email address 166 to send the email message by moving back into the pointing mode and moving his finger across touch pad 14 to the area corresponding to the email address.

The operator may select Internet telephone message panel 146 displayed in main menu 140 by moving his finger over touch pad 14 corresponding to the Internet telephone message panel. As described above, input peripheral 10 includes a microphone for receiving voice signals from and the operator and a transmitter for transmitting the voice signals to the enhanced TV. This enables Internet based telephony to be controlled and enjoyed by an operator while he is sitting on his couch in the family room for voice communications or to add an audio clip to an email message.

In response to the operator selecting the Internet telephone message panel 146, a telephone directory 170 is displayed on the enhanced TV as shown in FIG. 29. The operator may open received telephone messages by moving his finger over touch pad 14 corresponding to the telephone messages, for example, telephone message area 172. In response, the enhanced TV plays the recorded audible message. The operator may select a stored telephone number 174, dial the selected telephone number 176, talk and listen to the called party through input peripheral 10, and then hang up 178 using gesture commands on touch pad 14. To enter a telephone number that is not stored, the operator selects dial 174 and then enters the desired telephone number using on-screen numerical keyboard 180 displayed on the enhanced TV as shown in FIG. 30.

Input peripheral 10 includes a right side click button 50 located on a right side surface 52 and a right forward click button 54 located on a right rear surface 56. Buttons 50 and 54 perform the same functions as buttons 42 and 46 and may be used advantageously by a left handed person if function keys 18 are placed on the right side of touch pad 14. Accordingly, a left handed operator can hold input peripheral 10 by holding right side surface 52 with his right hand while manipulating touch pad 14 with his left hand.

To this end, input peripheral 10 includes a second scroll and pan region covered by a plate 17 and a second set of function keys covered by plate 19. Plates 17 and 19 can be removed to expose the second scroll and pan region and the second set of function keys to enable a left handed operator to hold input peripheral 10 and manipulate the second set of function keys with the operator's right hand while manipulating the second scroll and pan region with the operator's left hand. Plates 17 and 19 can be placed over first scroll and pan region 16 and first set of function keys 18 to prevent inadvertent access to these regions by the left handed operator. In essence, input peripheral 10 includes mirrored sets of scroll and pan regions, function keys, and buttons to enable use by either a right handed or left handed operator.

User-definable function keys 18 perform operations based on the function (i.e., macros, tools, menu choices, etc.) assigned to the function keys by the operator. When the operator presses or taps a function key with the holding hand the assigned operation is performed. Some function keys such as “volume up” will repeatedly perform the assigned operation while the function key is held down. Other function keys perform their respective operation only once each time the function key is pressed. The personalized functions are chosen from menus of presentation effects, multimedia controls, browser commands, macros, and application launching shortcuts.

Specific functions can be assigned to the function keys using the graphical user interface. The interface contains a tool kit of presentation, navigation, and pen input tools. Among these tools are blank with reveal, zoom, send keystroke(s), program launch, presentation launch, spotlight, pointer/stamp shapes, capture image, clear screen, scribble, write, speed dial, phone/address book, show pen tool control window, pre-set a control, i.e., change ink color, nib size, nib angle, nib shape, or eraser size to a specific setting, jump to a control, volume up/down, mute, etc.

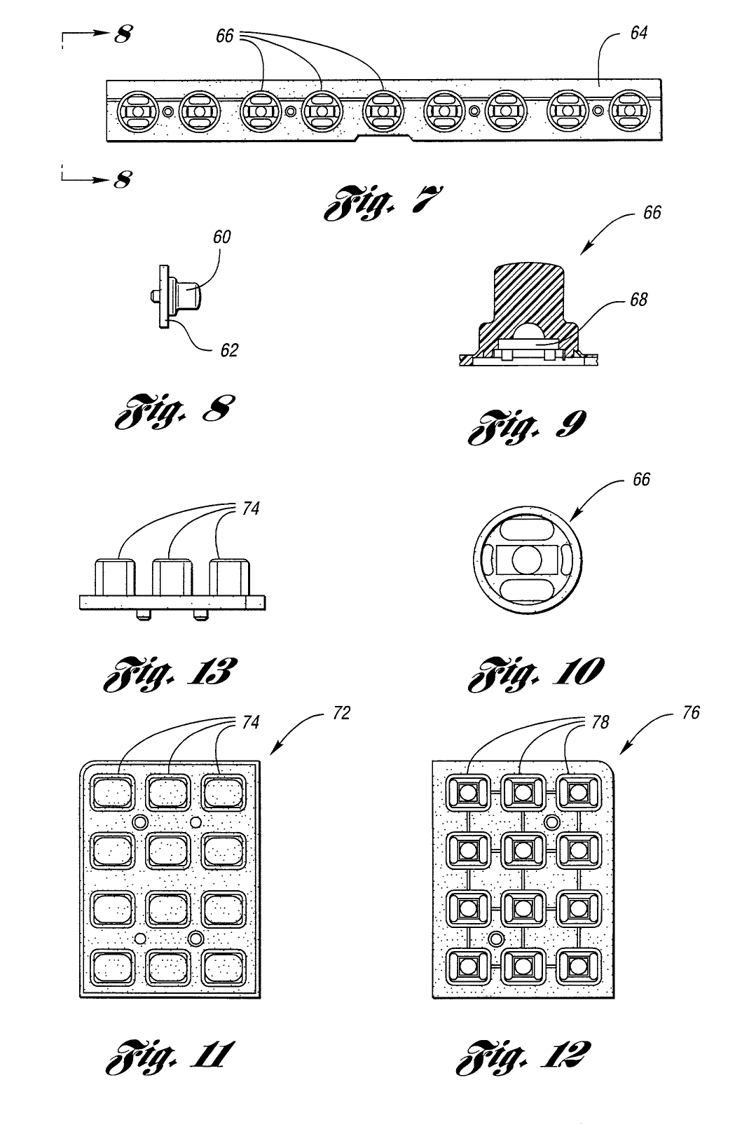

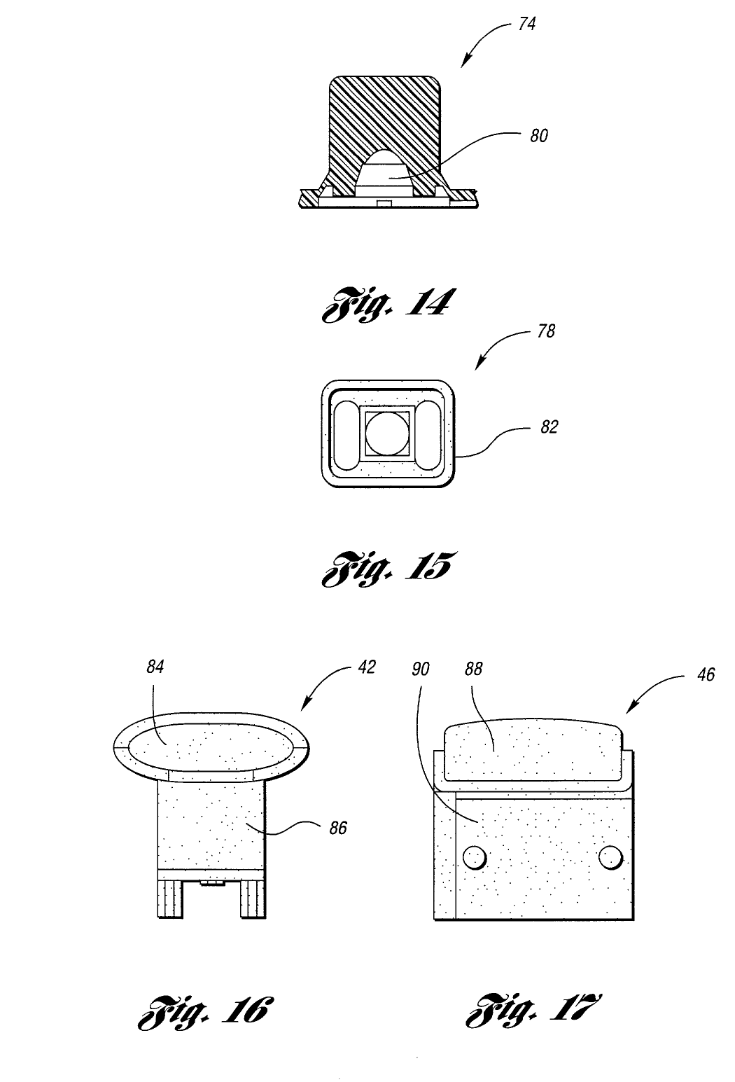

Referring now to FIGS. 5-10, detailed drawings of activation mode buttons 20 are shown. Activation mode buttons 20 include a top strip 60 having a plurality of buttons 62 and a bottom strip 64 having a plurality of corresponding electrically conductive pads 66. As shown best in FIGS. 9-10, button 62 includes an actuating portion 68 which engages a corresponding conductive actuating portion 70 of pad 66 when the button is pressed or tapped causing the mode linked to that button to be activated.

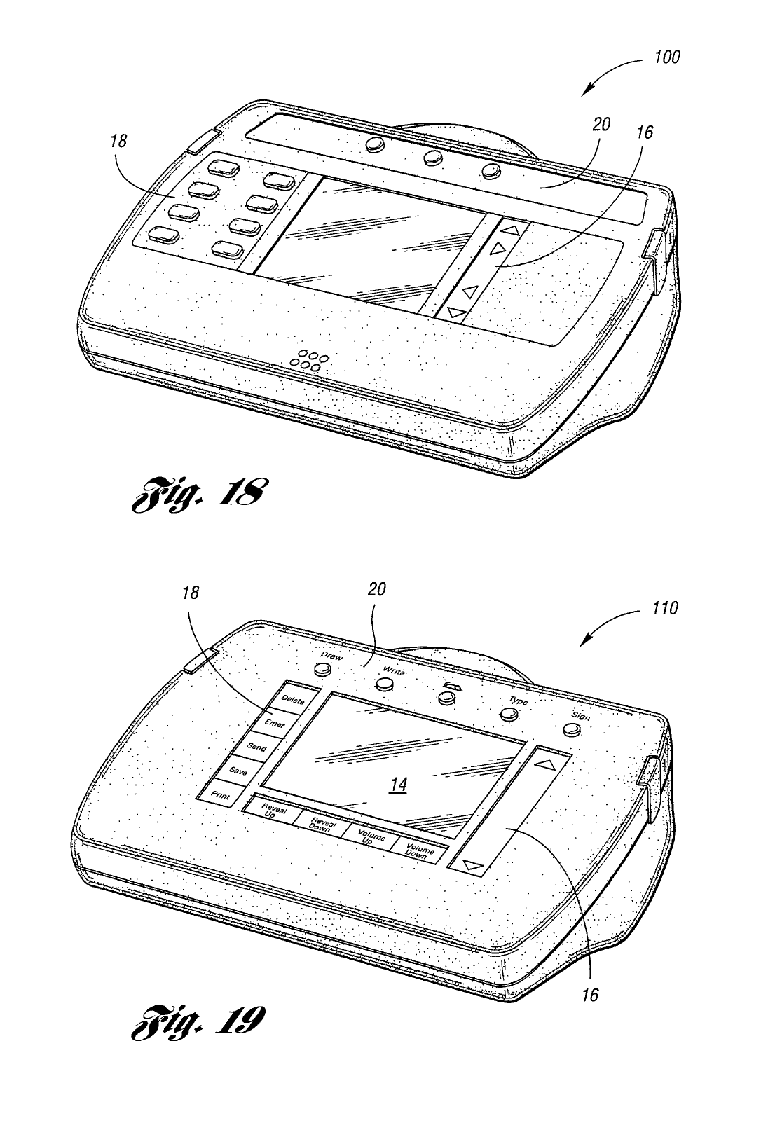

Referring now to FIGS. 11-15, detailed drawings of user-definable function keys 18 are shown. Function keys 18 include a top portion 72 having a plurality of buttons 74 and a bottom portion 76 having a plurality of corresponding electrically conductive pads 78. As shown best in FIGS. 14-15, button 74 includes an actuating portion 80 which engages a corresponding conductive actuating portion 82 of pad 78 when the button is pressed or tapped by a finger of the hand holding input peripheral 10 causing the function linked to that key to be activated.

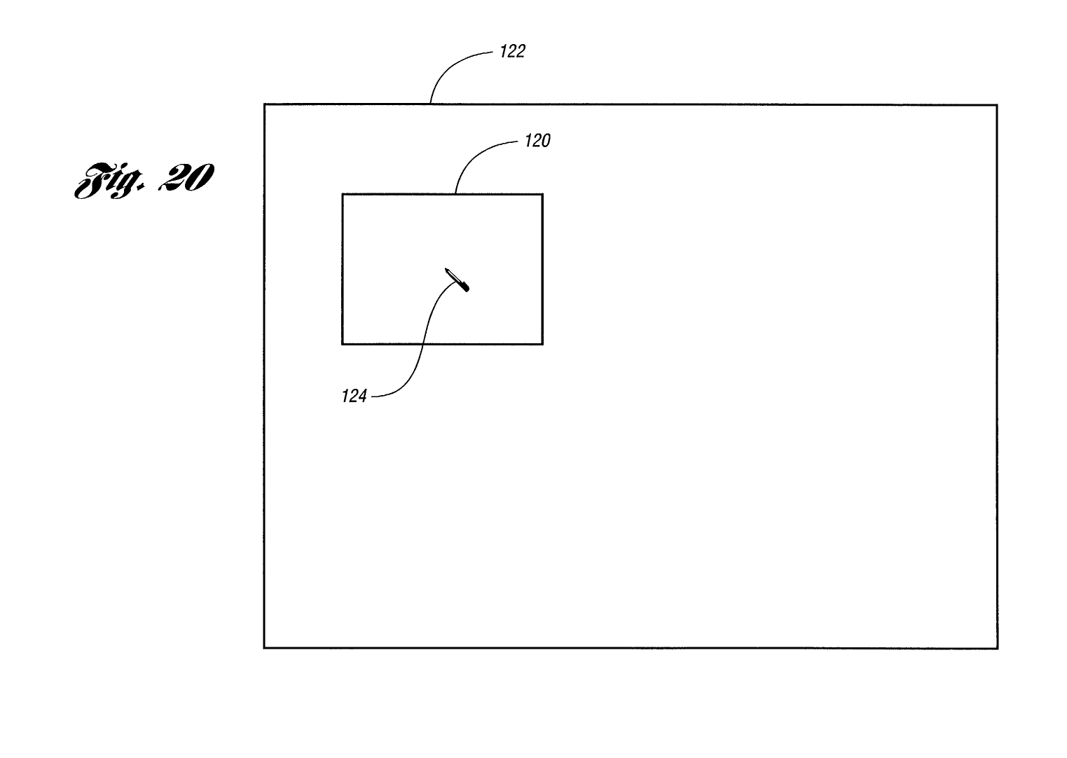

Referring now to FIG. 16, a side click button 42 (or 50) is shown. Side click button 42 includes a human digit engaging surface 84 and an actuating portion 86. By clicking engaging surface 84, actuating portion 86 engages a corresponding conductive actuation portion (not shown) of input peripheral 10 to activate side click button 42.

Referring now to FIG. 17, a forward click button (or paddle) 46 (or 54) is shown. Forward click button 46 includes a human digit engaging surface 88 and an actuating portion 90. By clicking engaging surface 88, actuating portion 90 engages a corresponding conductive actuation portion (not shown) of input peripheral 10 to activate forward click button 46.

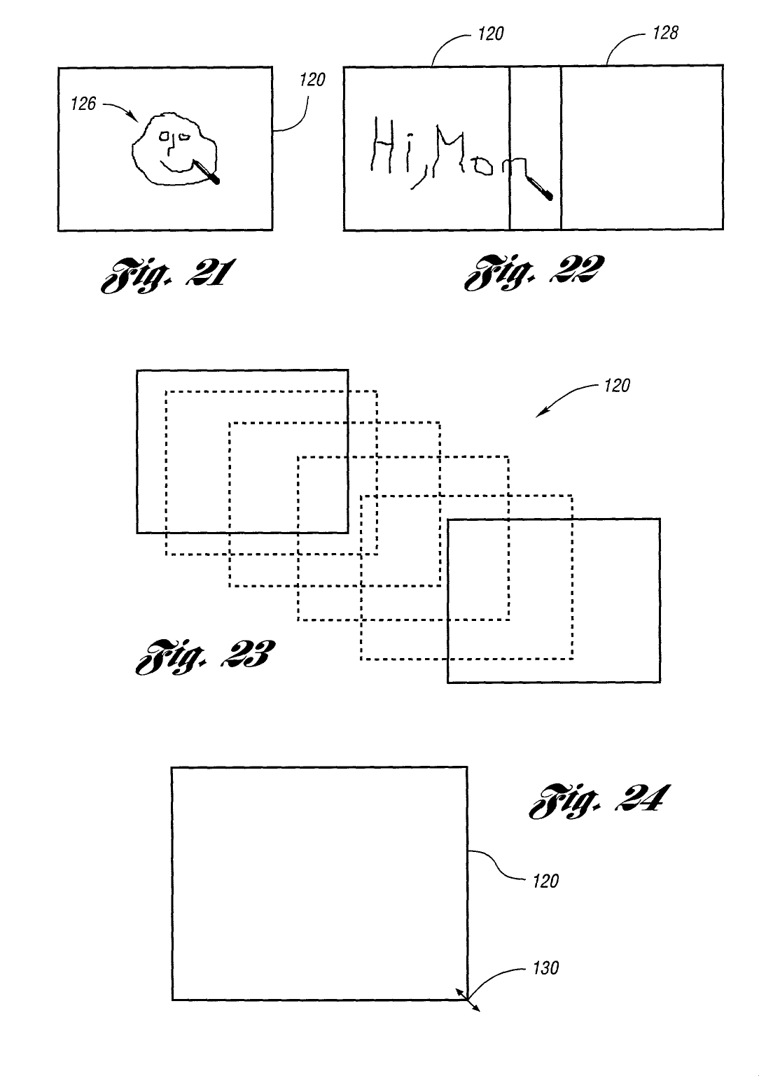

Referring now to FIGS. 18-19, a remote computer input peripheral 100 and 110 in accordance with a second and third embodiment, respectively, of the present invention is shown. Input peripheral 100 differs from input peripheral 10 in the number of user-definable function keys 18 and activation mode buttons 20. Input peripheral 110 differs from input peripheral 10 in that user-definable function keys are arranged around the perimeter of touch pad 14, the number of activation mode buttons 20, and pan and scroll region 16 provides only scrolling (up and down) arrows.

Thus it is apparent that there has been provided, in accordance with the present invention, a remote computer input peripheral that fully satisfies the objects, aims, and advantages set forth above.

While the present invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims.

What is Claimed Is:

1. A hand-held remote computer input peripheral for communicating with a host computer having a display screen, the input peripheral comprising:
a housing having a top surface, first and second opposed side surfaces, and a rear surface, wherein an operator holds the housing in space by gripping the first side surface with a first hand;
a plurality of activation mode buttons positioned in the top surface of the housing, each of the activation mode buttons corresponding to a respective activation mode of the touch pad for controlling the display screen, the activation modes of the touch pad including a text entry mode for entering text on the display screen and a cursor control mode for controlling a cursor on the display screen, wherein the operator switches between activation modes by pressing the activation mode buttons with the second hand; and
a touch pad positioned in the top surface of the housing, wherein the operator manipulates the touch pad using a second hand while holding the housing with the first hand to perform functions associated with the activation modes for controlling the display screen.

2. The input peripheral of claim 1 further comprising:
a plurality of function keys positioned in the top surface of the housing, each of the function keys corresponding to a respective function, wherein the operator actuates functions by pressing the function keys using the first hand while manipulating the touch pad with the second hand.

3. The input peripheral of claim 1 further comprising:
a click button positioned on the housing to be actuated by the first hand of the operator to perform functions associated with the activation modes for controlling the display screen, wherein the operator actuates the click button with the first hand while manipulating the touch pad with the second hand to control the display screen.

4. The input peripheral of claim 3 wherein:
the click button is positioned on the first side surface to be actuated by the operator using the thumb of the first hand.

5. The input peripheral of claim 3 wherein:
the click button is positioned on the rear surface adjacent to the first side portion to be actuated by the operator using the forefinger of the first hand.

6. The input peripheral of claim 1 further comprising:
a pan and scroll region adjacent to the touch pad, wherein the operator manipulates the pan and scroll region using the second hand to control the display screen.

7. The input peripheral of claim 1 wherein:
the operator manipulates the touch pad using a finger of the second hand.

8. The input peripheral of claim 1 wherein:
the operator manipulates the touch pad using a stylus held by the second hand.

9. The input peripheral of claim 1 wherein:
the text entry mode includes an annotation mode for enabling the operator to draw on to the display screen and a type mode for enabling the operator to print text on to the display screen.

10. The input peripheral of claim 9 wherein:
the operator draws on to the display screen in the annotation mode by moving a finger of the second hand across the touch pad.

11. The input peripheral of claim 9 wherein:
the operator prints text on to the display screen in the type mode by moving a finger of the second hand across the touch pad to handwrite the text, wherein conversion software converts the handwritten text to printed text.

12. The input peripheral of claim 9 wherein:
the operator prints text on to the display screen in the type mode by moving a finger of the second hand across the touch pad to select letters of an on-screen keyboard displayed on the display screen.

13. The input peripheral of claim 1 wherein:
the cursor control mode allows the operator to manipulate the touch pad such that the input peripheral functions as a computer mouse.

14. The input peripheral of claim 3 wherein:
the cursor control mode allows the operator to manipulate the touch pad in conjunction with the click button such that the input peripheral functions as a computer mouse.

15. The input peripheral of claim 1 further comprising:
a microphone for receiving audio signals and a speaker for transmitting audio signals, wherein the activation modes further include an Internet telephony mode for enabling Internet telephonic communication with another operator through the host computer, the microphone, and the speaker.

16. The input peripheral of claim 1 further comprising:
a microphone for receiving audio signals, wherein the operator generates an audible command into the microphone to control the display screen.

17. A hand-held remote computer input peripheral for communicating with a host computer having a display screen, the input peripheral comprising:
a housing having a top surface, first and second opposed side surfaces, and a rear surface, wherein an operator holds the housing in space by gripping the first side surface with a first hand;
a plurality of activation mode buttons positioned in the top surface of the housing, each of the activation mode buttons corresponding to a respective activation mode of the touch pad for controlling the display screen, the activation modes of the touch pad including an annotation mode for drawing on the display screen, a printed text entry mode for entering printed text on the display screen, and a cursor control mode for controlling a cursor on the display screen, wherein the operator switches between activation modes by pressing the activation mode buttons with the second hand;
a touch pad positioned in the top surface of the housing, wherein the operator manipulates the touch pad using a second hand while holding the housing with the first hand to perform functions associated with the activation modes for controlling the display screen; and
a click button positioned on the housing to be actuated by the first hand of the operator to perform functions associated with the activation modes for controlling the display screen, wherein the operator actuates the click button with the first hand while manipulating the touch pad with the second hand to control the display screen.

18. The input peripheral of claim 17 wherein:
the operator draws on to the display screen in the annotation mode by moving a finger of the second hand across the touch pad.

19. The input peripheral of claim 17 wherein:
the operator prints text on to the display screen in the type mode by moving a finger of the second hand across the touch pad to handwrite the text, wherein conversion software converts the handwritten text to printed text.

20. The input peripheral of claim 17 wherein:
the operator prints text on to the display screen in the type mode by moving a finger of the second hand across the touch pad to select letters of an on-screen keyboard displayed on the display screen.
